(19) United States
(12) Patent Application Publication
(10) Pub. No.: US 2002/0025808 A1
(43) Pub. Date: Feb. 28, 2002

(54) Dual signaling channel communication system and method

(76) Inventor: Victor E. Acuna, Santiago (CL)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/758,356

(22) Filed: Jan. 12, 2001

Related U.S. Application Data
(60) Provisional application No. 60/228,858, filed on Aug. 30, 2000.

(51) Int. Cl. H04Q 7/20

(52) U.S. Cl. 455/426; 455/414; 455/517; 455/434

(57) ABSTRACT

A dual signaling channel telephone system that in addition to the conventional wire channel between the subscriber telephone set and the central office switch, includes a wireless signaling channel between the subscriber telephone set and a central platform. This second wireless channel is aimed to transmit status, control information or to send any type of information from external systems, such as e-mail and voice-mail systems, to the subscriber to activate optical or acoustic indications or message display on the subscriber telephone set or external devices.

### CLAIM TO PRIORITY

This application claims priority to U.S. provisional application Ser. No. 60/228,858 filed Aug. 28, 2000, which is incorporated herein in its entirety.

### TECHNICAL FIELD OF THE INVENTION

The present invention relates to communication over a network, and in particular, to transmitting messages using a dual signal channel telephone network.

### BACKGROUND OF THE INVENTION

Most telephone systems existing in the world use two basic transmission media to communicate with the customer; i.e. metallic wires or wireless radio. In both cases, the media is used to transport the information that sets up the voice or data connection path and later the voice or data path itself.

Wired systems include the traditional and familiar telephone that has served for many years providing reliable, high quality and fairly economical connections. Wired systems include, for example, devices wired to a telephone line and that are capable of (1) establishing a connection by dialing a number corresponding to a second or a variety of parties, and (2) receiving calls through the public telephone network. Telephone sets include, but are not limited to, rotary dial telephones, DTMF telephones, data phones, video text phones, video phones and speaker phones. The technology uses a terminal (e.g. telephone set) that does not maintain a live connection with the system intelligence, and is inactive until either a ring signal is sent to it or the hand set goes off-hook. Thus, in its basic form, the telephone set is unable to receive any other signal over its transmission media. Some techniques, such as multiplexing and or advanced class services may allow the reception of messages over the same media at a substantial cost.

Wireless systems originated as a way to serve distant customers. As technology allowed, they evolved into one of the fastest growing industries of our time, namely, the mobile industry. Mobile technology requires, as part of its basic operational design, the maintenance of an open data channel between a mobile phone and the fixed infrastructure. The existence of that channel, and its capability to transport more than the basic information required to establish and maintain a communication, gave way to new innovative possibilities such as short messaging, notification, internet access, etc.

Many people believe that wired line telephones in advanced countries will soon be a thing of the past, being replaced by mobile phone. Even in less advanced countries, it is possible that mobile technology will replace the conventional telephone at a later date. The reasons for the replacement are argued to be the ubiquity and advanced services provided by mobile technology, the question being the remaining life of the wired telephone.

The wired line telephone today has clear advantages over mobile, such as reliability, quality, and no power requirement such as batteries, that will be difficult to overcome in the near future. Additionally, there is already a wired infrastructure in place that would be extremely costly to replace with a wireless system. The disadvantages of non-ubiquity is part of the nature of the wired telephone and will not change. However, the advanced services provided by technology can be matched by employing the structure disclosed in the present application.

### SUMMARY OF THE INVENTION

In one embodiment of the present invention, there is a dual signaling channel telephone system. The system includes, for example, a wired signaling channel including a telephone central office, and a telephone set, a wireless signaling channel including a central platform to receive messages from a message generator and to generate a radio frequency signal activated by said central platform and broadcast in coded form to a receiver-detector that is part of said telephone set including a device to decode said radio frequency signal and, status indicators or message display activated by said decoded signal.

In one aspect of the invention, the messages are conveyed to the telephone set and include indications, notifications or any information content for delivering via voice mail, e-mail, fax and internet.

In another aspect of the invention, the wired signaling channel transmits signals independently of an on hook-off hook status of the said receiver-detector.

In still another aspect of the invention, the system includes an indicating device responsive to signals received from said wireless signaling channel.

In yet another aspect of the invention, the system further includes a device to activate external devices in response to signals received from said wireless signaling channel.

In another embodiment of the invention, there is a dual signaling telephone system. The system includes, for example, a network receiving messages from message generators, a central platform broadcasting coded messages based on the messages generated by the message generators and a receiver-detector receiving the coded messages and generating a signal to activate a signaling device associated with a telephone.

In one aspect of the invention, the messages are supplied to the network in at least one format and forwarded to the central platform for coding.

In another aspect of the invention, the telephone outputs the decoded message either audibly or visually.

In yet another embodiment of the invention, there is a central platform for use in a dual signaling channel telephony network. The central platform includes, for example, a first communication processor to receive incoming messages coded in a specified format, a central processor authenticating relevant portions of the messages and a second communications processor sending outgoing messages from the central processor, the outgoing messages including RF addresses for encapsulation and transmission over an RF network.

In one aspect of the invention, the central platform also includes an RF translator to transmit messages over an RF network for delivery to a local telephone set and a server including a database storing user profiles and related information.

In yet another embodiment of the invention, there is a dual signal channel telephone system for use in a telephony network. The system includes, for example, a receiver to detect incoming RF signals and receive messages when the detected signal is addressed to the receiver and an output device to deliver the message via the telephone.

In one aspect of the invention, the output device is at least one of a speaker, LED or LCD.

In still another embodiment of the invention, there is a method of delivering messages to a telephone in a dual signal telephone network. The method includes, for example, broadcasting a message in a coded format having been received from a message generator via the network and receiving the message and generating a signal to activate a signaling device associated with the telephone in order to alert a user of the telephone that a message is present.

In one aspect of the invention, the method also includes sending the message from a network accessible device to a central platform and delivering the message received by the telephone on an output of the telephone.

### BRIEF DESCRIPTION OF THE DRAWINGS

In the drawings, to which reference will be made in the detailed description, similar reference characters have been employed to designate corresponding parts throughout the several views.

FIG. 1 is a block diagram showing an embodiment of the invention.

FIG. 2 is a block diagram illustrating a central platform and a radio frequency base station forming parts of the invention.

FIG. 3 is a block diagram showing a typical subscriber installation.

FIG. 4 is illustrates an exemplary flow diagram.

### DETAILED DESCRIPTION OF THE INVENTION

The invention is based on the provision of a separate, additional wireless signaling channel that communicates with a wire line telephone, complementing the existing channel and signaling protocol. The duality of signaling allows the possibility of provisioning many services, comparable to those offered by a wireless system. The wireless signaling channel allows the conventional telephone system to continue operating in the normal way while adding supplemental features, and avoids changes to the existing infrastructure.

The wireless signaling channel can be transmitted over a low capacity radio channel that is shared by subscribers on a coded basis. Radio channel signaling similar to those used by unidirectional paging systems, can support over one million subscribers. Other radio channels can be added for more subscribers or more demanding services. The transmitted radio messages are received by a receiver-detector associated with the receiving telephone. The message(s) instruct the telephone to perform a given operation or notify its user of actions to be taken.

The system includes, for example, a central platform connected via data channels to message generators such as ISP (e-mail status) and telephone operators (voice mail status). The central platform sends a message through, for example, a radio station that is received by receiver detectors within the signaling range, but which activates the addressed receiver(s). The receiver activates the telephone to do preprogrammed functions, or to display information to the telephone user.

The return channel for additional signaling, voice or data functions can be the regular telephone system, including the telephone traditional functions, the wire line, central offices and other infrastructure. A more detailed description is provided below.

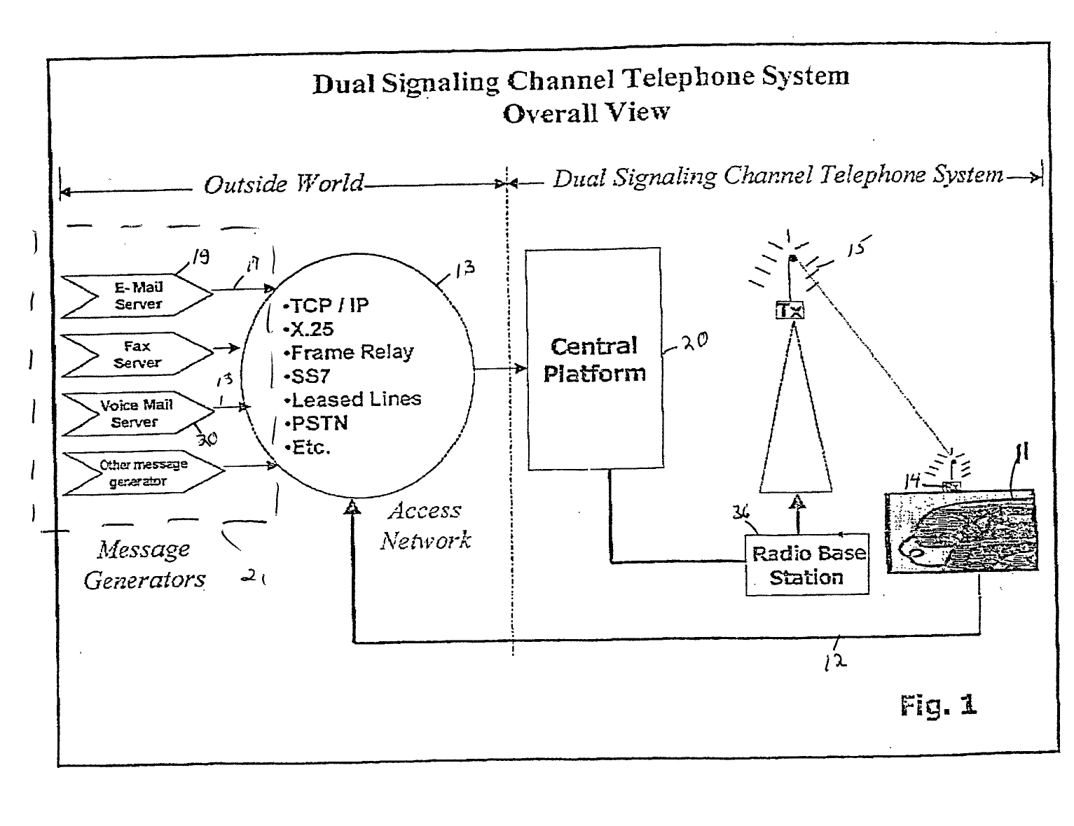

FIG. 1 illustrates one embodiment of the present invention. System includes, for example, conventional telephone set 11 connected by a hard wire pair 12 to a central telephone office part of the public switched telephone network (PSTN) 13. Associated with the telephone 11 is a receiver-detector 14 which is capable of receiving coded radio frequency signals transmitted by transmitter 15.

Public or private networks (e.g. LANs, WANs, internets, etc.) can be connected by channels 17 and 18 to, for example, stored e-mail and stored voice mail systems, 19 and 20 respectively. It is understood that additional services including a fax server, and others may also be interconnected in a similar manner as readily understood by one having ordinary skill in the art. The stored email and voicemail systems 19 and 20 form part of original message generators 21. Messages generated by any one of message generators 21 are sent to a central platform 22 which in turn generates and continually broadcasts coded messages through a radio frequency signal which is continuously received by each individual receiver-detector 14. The receiver-detector 14 includes a decoder which responds to signals including a code recognized by receiver-detector 14 when received from the central control platform 22.

Each receiver-detector 14 generates a corresponding signal to activate a signaling device (e.g. an LED) associated with telephone set 11, which will be observed by the telephone subscriber upon entering a room in which the telephone set is located. Once an activated signal has been observed, the subscriber or user dials a predetermined telephone number provided by the central telephone office which, in turn, will playback the recorded voice mail. Playback can come in numerous forms, such as visually or audibly.

Messages intended for individuals or users not subscribed to the system can be notified by subscribers to the system. Thus, the system is particularly suitable for use in relatively less economically developed areas where wired telephone subscriber service is limited.

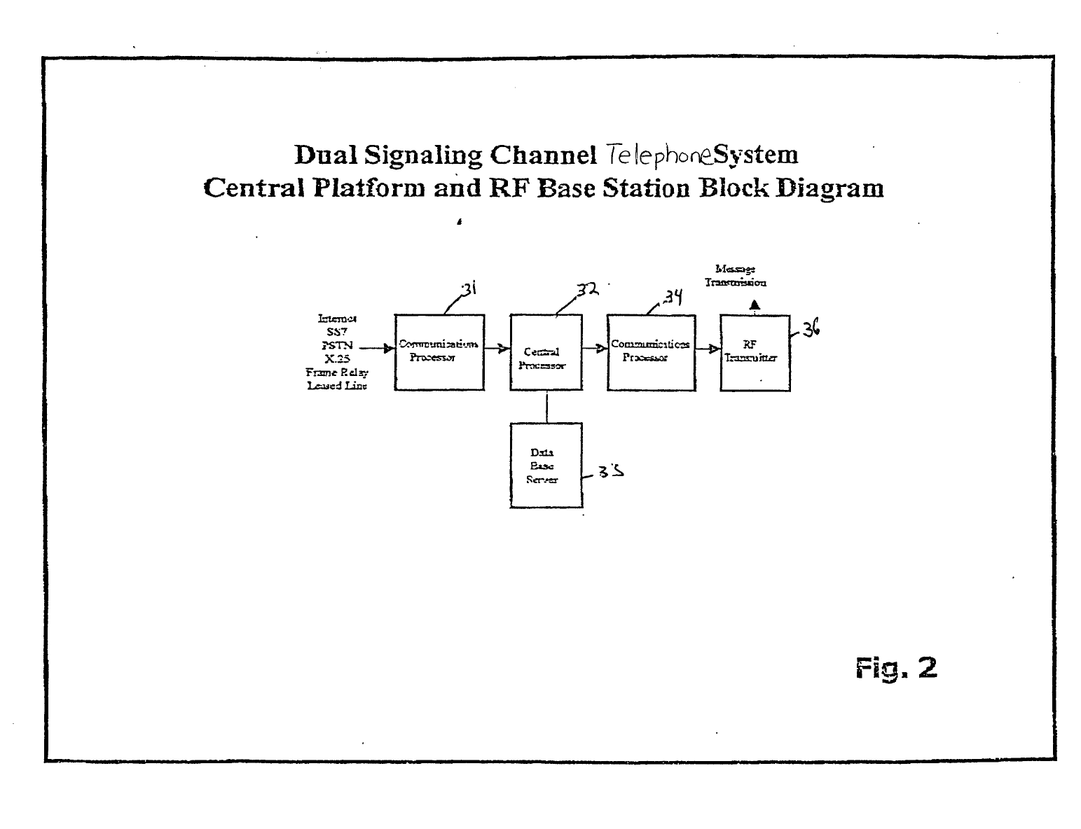

Referring to FIGS. 1 and 2, the central platform 22 includes, for example, a first communications processor 31 which receives incoming messages, coded in accordance with the transmission network used. Messages are recovered and transferred to the central processor 32.

The central processor 32 reads relevant fields of the messages for authentication. Once the message(s) have been authenticated, a query is sent to a database server 33 in order to obtain the subscriber's RF address and other information necessary to have the message sent out to the subscriber. The database server 33 also includes statistical and traffic information for commercial and engineering analysis.

The database server 33 runs, for example, a commercial database that can be updated by an operations company and by the system itself. The database includes information related to subscribers and their profiles, status and RF addresses of the subscriber's dual signaling channel telephones. The RF address is entered when the installation of a dual signaling channel telephone occurs and the registration and testing sequences have been executed.

A second communications processor 34 sends outgoing messages from the central processor 32 to the RF transmitter 36 along with the subscriber's RF addresses for encapsulation and transmission over the RF network. For example, messages received from the central platform 22 (FIG. 1) are transmitted by a single RF transmitter 36 over an associated antenna 15. To increase coverage (i.e., transmitting distance), there may be a number of transmitters (not shown) distributed geographically and operating on the same RF channel, or, if interferences are expected, on separate RF channels.

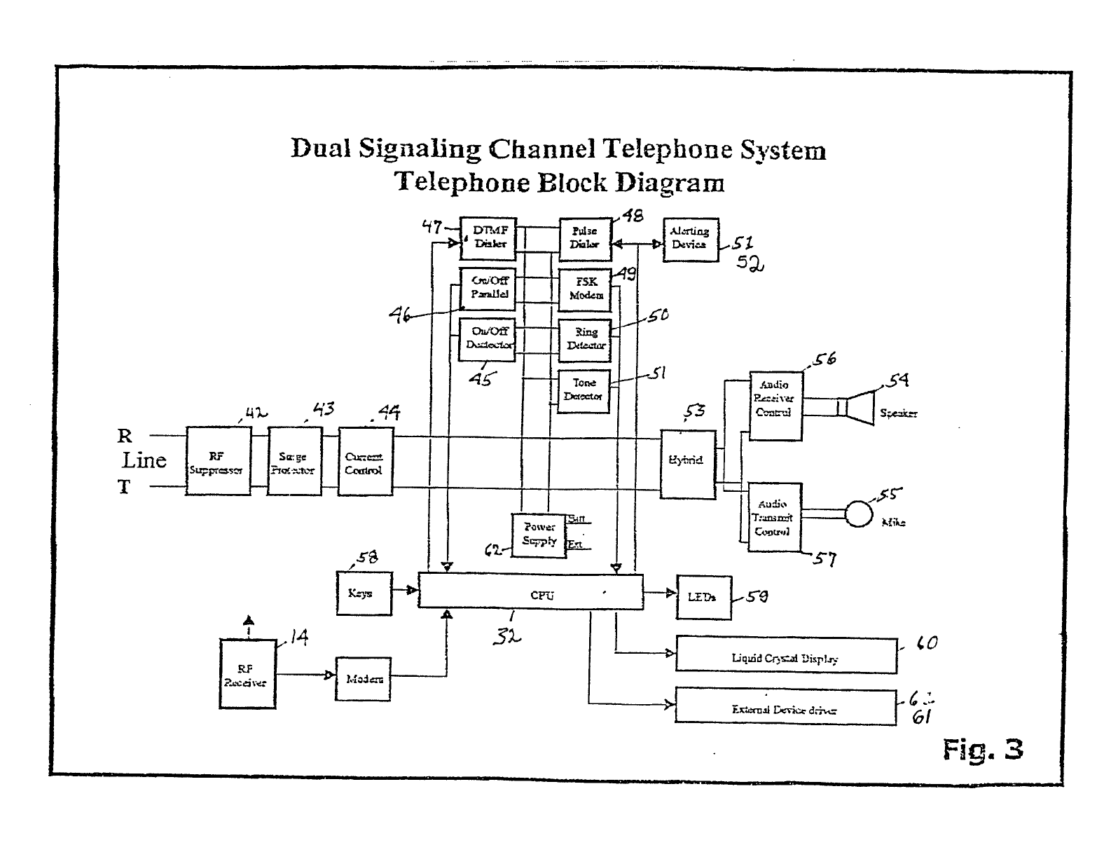

FIG. 3 illustrates functional components at the subscriber's premises that make the telephone suitable for operation in a dual signaling channel environment. Components include, for example, the receiver-detector 14 which detects RF signals in its assigned frequency band, demodulates them, and transfers them in digital form to the central processing unit (CPU) 32. An RF suppressor 42 prevents unwanted RF signals from entering the telephone through the physical line. A surge protector 43 prevents dangerous voltages and currents from injuring the subscriber and destroying parts of the telephone. A current control 44 encompasses a current measuring device to control electro-acoustic conversion depending upon the line length. An on-off detector 45 is coupled to the hook switch of the telephone, and performs loop closure and opening of the line.

An on-off parallel telephone detector 46 detects when parallel telephones go off/on-hook in order to update the information included in the central processing unit 32, and signals these states (on/off) to the user. Detector 46 also detects special dialing sequences entered by parallel telephones aimed at activating or deactivating features provided by the central office switch. A DTMF dialer 47 outpulses DTMF sequences when entered via the dial pad, special feature keys, memory or from a caller-ID list (not shown). A pulse dialer 48 outpulses dial pulses when entered via a dial pad, from memory or from the caller-ID list, provided it has been enabled. An FSK modem 49 detects FSK signals on the line. These signals may include on-hook FSK signals transmitted by the switch for calling party identification and voice message waiting indication (if supported by the switch), as well as off-hook FSK signals transmitted by the switch for call waiting calling party identification (if supported by the switch). The FSK modem 49 outputs valid information to the central processing unit 32 for further processing. A ring detector 50 detects ringing current on the line and activates either the alerting device 52, the FSK modem 49 or both. The alerting device 52 generates an acoustical or visual signal that indicates to the subscriber that an incoming call has arrived. A tone detector 51 detects the various tones provided by the central office switch, including, for example, dial tone, busy tone, fast busy tone, special (stutter) dial tone, and call waiting indication.

A hybrid 53 converts the two wire audio signals of the line into a four wire system connected to a receiver 54 (e.g. speaker) and the transmitter 55 (e.g. microphone) which are preferably incorporated into the telephone handset.

An audio receiver control 56 controls the receiving electro-acoustic conversion to keep the receiving reference equivalent, sum of receiving and transmitting reference equivalent, and side tone reference equivalent within accepted standards for varying line lengths.

A similar audio transmitter control 57 controls the transmitting electro-acoustic conversion to keep the transmitting reference equivalent, sum of receiving and transmitting reference equivalent and side tone reference equivalent within accepted standards for varying line lengths.

The keys 58 comprise the usual twelve or sixteen key dial pad and all other necessary functional keys of the telephone, and are preferably positioned on the apparatus (e.g. telephone) case.

The telephone may be equipped with a varying number of light emitting diodes (LEDs) 59 to signal a variety of conditions, including: a) voice message waiting indication; b) call waiting indication; c) conference call in progress; d) do not disturb feature activated; e) call transfer feature activated; f) new call; g) in-use/parallel telephone off-hook, and other; and h) user defined functions. The logic of the central processing unit 32 lights or turns off these LEDs.

A liquid crystal display (LCD) 60 may be optionally provided. This display can show, for example, the following information: a) caller identification on incoming calls; b) list of the caller-IDs for the last received calls. This list can be scrolled, items eased or particular items selected to initiate outgoing calls; c) icon to indicate voice message waiting indication (as an alternative to or together with the LED); d) icon to indicate call waiting indication in conjunction with the calling subscriber's ID if supported by the switch; e) text indicating that a conference is in progress (as an alternative to or together with the LED); f) text indicating that the don't disturb feature has been activated (as an alternative to or together with the LED); g) text indicating that the call transfer feature has been activated (as an alternative to or together with the LED); and h) text indicating that one or several new calls have entered but were not answered (as an alternative to or together with the LED).

An external driver device 61 can activate external circuits upon receipt of certain messages via the RF receiver, such as activating a fax machine.

The central processing unit 32 may also fulfill the following functions: a) recognize its own address when RF messages are received. The message content is handed over to the appropriate transmission path to light an LED (for example, voice message waiting indication), display a message on the LCD or to activate a particular external device; b) receive FSK messages over the line and hand them over to the appropriate path to light a LED or display a message on the LCD (caller ID, voice message waiting indication, call waiting indication); c) process keystrokes; d) activate the alerting device in accordance with the phases of a call in progress; e) handle the incoming calling line identification list and its manipulation by the subscriber; f) store lists of directory numbers entered by the subscriber and allow its manipulation (retrieve, erase, etc.).

A power supply 62 provides electrical energy to the different modules of the telephone from a variety of sources, including off hook current, on hook current, battery and external power supply. The particular supply to be implemented depends on the number of features included in the telephone.

### Operation

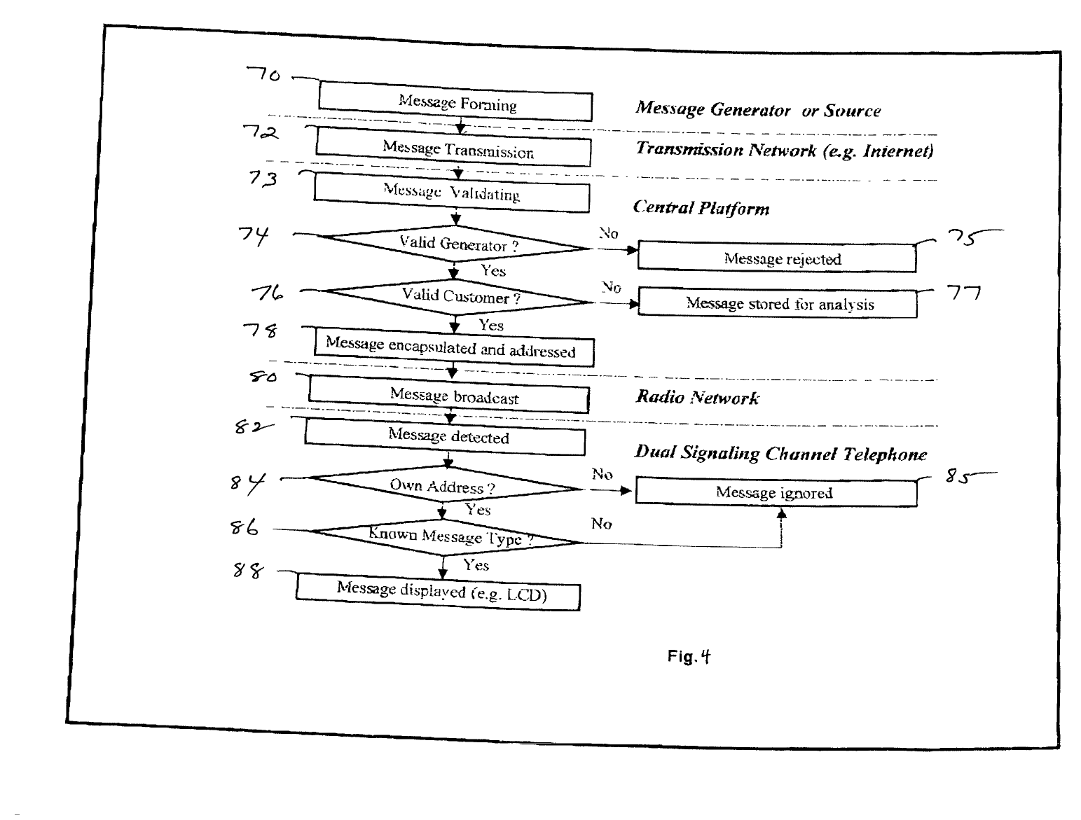

Operation of the system is now described with respect to FIG. 4. FIG. 4 is an exemplary flow diagram of the present system. In the preferred embodiment, messages are formed/created at 70 by at least one of message generators 21, and transmitted over the network 13. Messages are then validated at 72 by the central platform 22. Validation occurs by first validating the generator (i.e. source). Messages from invalid operators are rejected (75). If it is determined at 74 that the generator is valid, then the central platform 22 determines whether the user (i.e. customer) is valid at 76. If the customer is not validated (i.e. the customer is not properly registered with the system ), then the message is stored for further commercial and statistical analysis at 77. When the customer is properly validated at 76, then message is encapsulated and addressed at 78. After encapsulation and addressing, the message is broadcast using a radio frequency at 80. The broadcast message is detected by individual receiver-detectors 14 at 82, and a determination is made by the receiver-detector 14 whether or not to receive the message at 84. If the receiver-detector 14 determines that the message is not addressed to itself, then the message is ignored at 85. If, on the other hand, the receiver-detector 14 determined that the message is properly addressed, then the message is analyzed for type at 86. If the message type is not recognized, then the message is ignored at 85. Otherwise, the message is displayed on the telephone set corresponding to the receiver-detector 14 at 88 or some further action is taken.

### Incoming Messages

Whenever a predefined event occurs at one of the message generators 16-20, forming message generator 21, a message is sent to the central platform 22. In the preferred embodiment, the message is sent via network 13 using a protocol well know in the art, such as TCP/IP. The central processor 32 within the central platform 22 reads the relevant fields of the message for authentication. A query is sent to the database server 33 in order to access the subscriber's RF address and other information necessary to have the message sent out to the subscriber. If the message cannot be sent out, for example, because the subscriber has not yet been activated or because the customer's profile does not include a particular service, the message is stored for further analysis and/or customer service review.

If the message has been recognized as valid and an RF address was found, the message is encapsulated for RF transmission, modulated and transferred, to the RF transmitter. The RF transmitter, located at the radio base station 36 in one embodiment, transmits the messages as a radio signal that are received by the dual signaling channel telephones. The radio (i.e. signal) message received by the dual signaling channel telephone is decoded by receiver-detector 14, and the RF address number is verified and recognized as its own address. If correspondence with an internal mask is found, according to the type of message, the appropriate action is taken. The “internal mask” refers to a code in the receiver that identifies the type of message and prompts a certain action. For example, if the message is of the type “messages in mailbox” the “voice message waiting indication” LED or LCD icon is turned on. Conversely, if all messages of the subscriber's mailbox were read or erased, the incoming message turns the corresponding LED or LCD icon off.

If supported by the central office switch, the dual signaling channel telephone can also receive voice message waiting indication via the line, that will be detected and decoded by the FSK modem 49. The receiving message content is transferred to the central processing unit 32 which turns the corresponding LED or LCD icon on or off.

### Incoming Calls to the Telephone

In one embodiment of the invention, on incoming calls, the switch sends ringing current down the line detected by the ring detector 50, which in turn informs the central processing unit 32 of this event. The central processing unit 32 awakens the FSK modem 49 and activates the alerting device 52. Between the first two ring bursts the switch sends FSK signals detected and demodulated by the FSK modem 49. The received message includes, for example, the calling line identification. The central processing unit 32 decodes received messages and displays it on the liquid crystal display 60, so that it may be read by the subscriber even before he or she lifts the handset. The calling line identification of calls are placed in a queue list, for example, in arriving order where they can be manipulated by the subscriber scrolling and erasing items or using them to initiate calls. If an incoming call is not answered, the calling line identification is placed in the calling line identification list, and placed in memory in the telephone and the new call LED is lit (alternatively the new call icon is turned on).

### Outgoing Calls from the Telephone

When the subscriber handset goes off-hook, this event is detected by the on/off hook detector 45 that closes the loop of the line. The subscriber can dial directly the desired number on the dial pad, or retrieve it from the calling line identification list or from memory, as well understood in the art. The tone detector 51 detects regular or special dial tones and informs the central processing unit 32 that outpulsing (i.e. dialing) may start. According to the activated dialer, the digits are placed in DTMF or dial pulse format on the line. Once a call is answered, the subscriber may dial additional digits, for example, for extension lines, in DTMF format, or other formats as understood by the skilled artisan.

### Call Waiting Indication at the Telephone

When a call is established, and a call waiting signal is received, an LED is lit (or alternatively an icon of the LCD). Pressing the call waiting key, the subscriber telephone outpulses a predefined DTMF sequence to put the interlocutor on hold and picks up the new call. Pressing the call waiting key periodically, the subscriber can toggle between both interlocutors, talking with one and leaving the other one on hold. If the switch supports calling line identification, Type 2, where the calling party number is displayed while the subscriber is in a established call status, upon receipt of the call waiting signal, the caller's identification is sent down the line and decoded by the FSK modem 49. This number is transferred to the central processing unit 32 and displayed on the LCD.

### Other Supplementary Services

The subscriber, by means of the method explained above may invoke other supplementary services such as three party conference, call transfer, do not disturb, access to his mailbox, etc., as readily understood by one having ordinary skill in the art.

### Registration and Testing of a Dual Signaling Channel Telephone

To register a dual signaling channel telephone address, once installed at the subscriber's premises, the installer enters his or her own telephone number and then initiates a call to the central platform 22. Upon successful “handshaking” between the telephone and the central platform, the telephone sends its own number and the RF address by means of DTMF pulses. The matched RF address and telephone number become permanent data at the data base 33 of the central platform 22. To test the correct match RF address, against the subscriber number, the central platform 22 sends a RF test message to the telephone. The telephone displays an appropriate text when the message is successfully received.

Various preferred embodiments of the invention have now been described in fulfillment of the objects of the invention. While these embodiments have been set forth by way of example, various other embodiments and modifications will be apparent to those skilled in the art. Accordingly, it should be understood that the invention is not limited to such embodiment, but encompasses all that which is described in the following claims.

We claim:

1. A dual signaling channel telephone system, comprising:
a wired signaling channel including a telephone central office, and a telephone set; and
a wireless signaling channel including a central platform to receive messages from a message generator and to generate a radio frequency signal activated by said central platform and to broadcast the messages to a receiver-detector in each telephone set.

2. The system in accordance with claim 1, wherein the messages are conveyed to the telephone set and include indications, notifications or any information content for delivering via voice mail, e-mail, fax and internet.

3. The system in accordance with claim 1, wherein said wireless signaling channel transmits signals independently of an on-hook/off-hook status of the said telephone set.

4. The system in accordance with claim 1, further comprising an indicating device responsive to signals received from said wireless signaling channel.

5. The system in accordance with claim 1, further comprising a device to activate external devices in response to signals received from said wireless signaling channel.

6. The system of claim 1, wherein the receiver-detector is connected to the telephone set and includes a device to decode said radio frequency signal and activates status indicators or message display activated by said decoded signal.

7. A dual signaling telephone system, comprising:
a network receiving messages from message generators;
a central platform broadcasting coded messages based on the messages generated by the message generators; and
a receiver-detector receiving the coded messages and generating a signal to activate a signaling device associated with a telephone.

8. The system according to claim 7, wherein the messages are supplied to the network in at least one format and forwarded to the central platform for coding.

9. The system according to claim 7, wherein the telephone outputs the decoded message either audibly or visually.

10. A central platform for use in a dual signaling channel telephony network, the central platform comprising:
a first communication processor to receive incoming messages coded in a specified format;
a central processor authenticating relevant portions of the messages; and
a second communications processor sending outgoing messages from the central processor, the outgoing messages including RF addresses for encapsulation and transmission over an RF network.

11. The central platform according to claim 10, further comprising:
an RF translator to transmit messages over an RF network for delivery to a local telephone set; and
a server including a database storing user profiles and related information.

12. A dual signal channel telephone system for use in a telephony network, comprising:
a receiver to detect incoming RF signals and receive messages when the detected signal is addressed to the receiver; and
an output device to deliver the messages via the telephone.

13. The system of claim 12, wherein the output device is at least one of a speaker, LED or LCD.

14. A method of delivering messages to a telephone in a dual signal telephone network, comprising:
broadcasting a message in a coded format having been received from a message generator via the network; and
receiving the message and generating a signal to activate a signaling device associated with the telephone in order to alert a user of the telephone that a message is present.

15. The method according to claim 14, further comprising:
sending the message from a network accessible device to a central platform; and
delivering the message received by the telephone on an output of the telephone.

16. A method of communication over a dual signaling telephone system, comprising:
receiving messages from message generators;
broadcasting coded messages based on the messages generated by the message generators; and
generating a signal to based on the coded messages to activate a signaling device associated with a telephone.

17. A method of communicating over a network, comprising:
receiving incoming messages coded in a specified format;
authenticating relevant portions of the messages; and
sending outgoing messages from a central processor, the outgoing messages including RF addresses for encapsulation and transmission over the network.
